(19) United States
(12) Patent Application Publication
(10) Pub. No.: US 2017/0083474 A1
(43) Pub. Date: Mar. 23, 2017

(54) DISTRIBUTED MEMORY CONTROLLER

(71) Applicant: Advanced Micro Devices, Inc., Sunnyvale, CA (US)

(72) Inventors: Mitesh R. Meswani, Austin, TX (US); David A. Roberts, Sunnyvale, CA (US); Yasuko Eckert, Bellevue, WA (US); Kapil Dev, Austin, TX (US); John Kalamatianos, Boxborough, MA (US); Indrani Paul, Austin, TX (US)

(21) Appl. No.: 14/862,011

(22) Filed: Sep. 22, 2015

(51) Int. Cl. G06F 13/42; G06F 13/18; G06F 12/08

(52) U.S. Cl. CPC G06F 13/4234; G06F 12/084; G06F 13/18; G06F 12/0862; G06F 2212/314; G06F 2212/603

(57) ABSTRACT

A plurality of first controllers operate according to a plurality of access protocols to control a plurality of memory modules. A second controller receives access requests that target the plurality of memory modules and selectively provides the access requests and control information to the plurality of first controllers based on physical addresses in the access requests. The second controller generates the control information for the first controllers based on statistical representations of the access requests to the plurality of memory modules.

### BACKGROUND

Field of the Disclosure

The present disclosure relates generally to processor systems and, more particularly, to memory elements in processor systems.

Description of the Related Art

Heterogeneous memory systems can be used to balance competing demands for high memory capacity, low latency memory access, high bandwidth, and low cost in processing systems ranging from mobile devices to cloud servers. A heterogeneous memory system includes multiple memory modules that operate according to different memory access protocols. The different memory modules can be implemented in different technologies. The memory modules share the same physical address space, which may be mapped to a corresponding virtual address range, so that the different memory modules are transparent to the operating system of the device that includes the heterogeneous memory system. For example, a heterogeneous memory system may include relatively fast (but high-cost) stacked dynamic random access memory (DRAM) and relatively slow (but lower-cost) nonvolatile RAM (NVRAM) that are mapped to a single virtual address range. Traditional access request scheduling algorithms have been designed for homogeneous memory systems and do not account for the different memory access characteristics of the different types of memory modules that may be implemented in a heterogeneous memory system, such as bandwidth, latency, power consumption, and endurance. The traditional memory scheduling algorithms may therefore introduce inefficiencies that reduce the overall performance of the system such as bottlenecks caused by access requests to slower types of memory.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some embodiments.

FIG. 2 is a block diagram of a processing system that implements a hierarchical memory controller in accordance with some embodiments.

FIG. 3 is a flow diagram of a method for selectively delaying access requests to one or more local controllers on a per-thread basis according to some embodiments.

FIG. 4 is a flow diagram of a method for identifying access patterns on a per-thread basis according to some embodiments.

FIG. 5 is a flow diagram of a method for enforcing quality-of-service (QoS) requirements on a per-thread basis according to some embodiments.

### DETAILED DESCRIPTION

The performance of a heterogeneous memory system may be improved by implementing a hierarchical, distributed memory controller that includes a master controller that receives access requests targeting a plurality of individual memory modules that operate according to a corresponding plurality of memory access protocols. The master controller distributes the access requests to local controllers associated with the individual memory modules based on the physical address indicated in the access request. The local controllers schedule the access requests based on the access protocol of the memory module served by the corresponding local controller (e.g., DDR3, DDR4, or PCM) and based on control information generated by the master controller using statistical representations of access requests to the plurality of individual memory modules. The master controller may generate priorities for the access requests of different threads based on an average response latency for access requests in the threads, an average bandwidth (e.g., as indicated by an amount of data transferred over a fixed period of time), or an average load (e.g., as indicated by a number of requests over a period of time) for the individual memory modules. Some embodiments of the master controller form a statistical representation by monitoring incoming requests from a last-level cache, e.g., by tracking the number of pending read or write requests to each local controller for different application threads indicated by thread identifiers in the access request. The master controller may also form a statistical representation based on feedback received from the local controllers. The feedback may include information indicating an average read or write bandwidth, energy consumption, detected errors, or average read or write latency of access requests. Some embodiments of the master controller prepend or append the control information to, or otherwise associate the control information with, the corresponding access requests.

Some embodiments of the master controller transmit explicit commands including control information, such as commands to open memory pages prior to arrival of an access request to the memory module where the pages reside or commands to prefetch data based on memory access patterns detected by the master controller. The data can be prefetched into data buffers located in the local controller, in the master controller or directly into the last-level cache. Detection of prefetch patterns such as linear strides on the physical address stream coming out of the last-level cache can be done at the master controller. In some embodiments, the master controller passes prefetch patterns to the local controllers which can then use the prefetch pattern to open/close pages of the memory module so that they minimize request completion time.

The control information may be used to set priorities, indicate latency-bound threads, or manage QoS requirements on a per-thread basis. In some embodiments, if the master controller identifies that a specific thread X experiences a considerable number of requests pending in one local controller A that access a high latency memory module (e.g. one type of NVRAM), it might decide to send explicit commands to another local controller B (accessing a lower latency memory such a DDR4 or GDDR5) to lower the priority of requests of thread X in local controller B so that other threads can experience a faster response time. In some embodiments, if the software (either user-level or operating-system-level) utilizes the lower latency memories (e.g. DDR4) for latency bound threads and the higher latency memories (e.g. NVRAM) for threads with large working sets, then the master controller can recognize the latency bound threads by monitoring the number of requests per thread ID to the lower latency memories and raise the priority of the request traffic for only those thread IDs by notifying the corresponding local controllers. In some embodiments, the master controller can be used to enforce QoS guarantees. The QoS guarantees can be expressed in the form of a maximum average response latency, minimum read/write bandwidth, and the like. The QoS settings that are used to indicate the QoS guarantees may be programmable via a basic input/output system (BIOS) so that user threads can be mapped to different QoS settings either by the user, the OS or by the system at run-time. These settings can be communicated to the master controller via the thread ID of each access request and a hardware table that includes the QoS settings per thread ID. The master controller can then enforce the QoS settings if it maintains knowledge of the QoS metrics on a thread basis as it monitors the memory traffic from a last level cache.

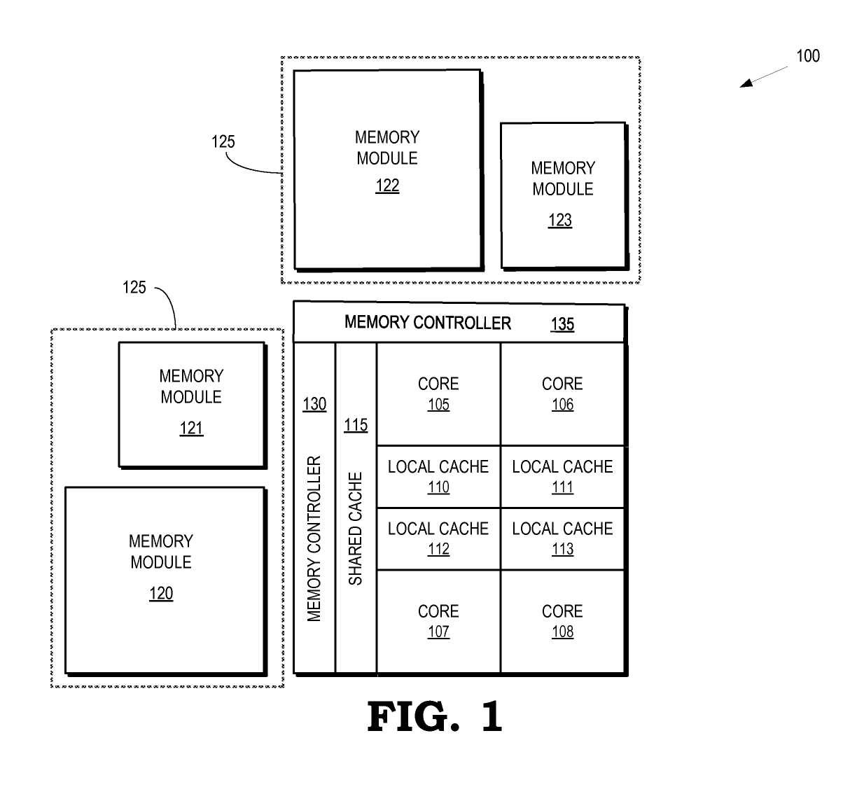

FIG. 1 is a block diagram of a processing system 100 in accordance with some embodiments. The processing system 100 includes multiple processor cores 105, 106, 107, 108 that are referred to collectively as the “processor cores 105-108.” The processor cores 105-108 can execute instructions independently or concurrently. While processing system 100 shown in FIG. 1 includes four processor cores 105-108, other embodiments of the processing system 100 may include more or fewer than the four processor cores 105-108 shown in FIG. 1. Some embodiments of the processing system 100 are formed on a single substrate, e.g., as a system-on-a-chip (SOC). The processing system 100 may be used to implement a central processing unit (CPU), a graphics processing unit (GPU), an accelerated processing unit (APU) that integrates CPU and GPU functionality in a single chip, a field programmable gate array (FPGA), an application specific integrated circuit (ASIC), and the like.

The processing system 100 implements caching of data and instructions, and some embodiments of the processing system 100 implement a hierarchical cache system. Some embodiments of the processing system 100 include local caches 110, 111, 112, 113 that are referred to collectively as the “local caches 110-113.” Each of the processor cores 105-108 is associated with a corresponding one of the local caches 110-113. For example, the local caches 110-113 may be L1 caches for caching instructions or data that may be accessed by one or more of the processor cores 105-108. Some or all of the local caches 110-113 may be subdivided into an instruction cache and a data cache. The processing system 100 also includes a shared cache 115 that is shared by the processor cores 105-108 and the local caches 110-113. The shared cache 115 may be referred to as a last level cache (LLC) if it is the highest level cache in the cache hierarchy implemented by the processing system 100. Some embodiments of the shared cache 115 are implemented as an L2 cache. The cache hierarchy implemented by the processing system 100 is not limited to the two level cache hierarchy shown in FIG. 1. Some embodiments of the hierarchical cache system include additional cache levels such as an L3 cache, an L4 cache, or other cache depending on the number of levels in the cache hierarchy.

The processing system 100 also includes a plurality of memory modules 120, 121, 122, 123, which may be referred to collectively as “the memory modules 120-123.” Although four memory modules 120-123 are shown in FIG. 1, some embodiments of the processing system 100 include more or fewer memory modules 120-123. The memory modules 120-123 may be implemented as different types of RAM. Some embodiments of the memory modules 120-123 are used to implement a heterogeneous memory system 125. For example, the plurality of memory modules 120-123 can share a physical address space associated with the heterogeneous memory system 125 so that memory locations in the memory modules 120-123 are accessed using a continuous set of physical addresses. The memory modules 120-103 may therefore be transparent to the operating system of the processing system 100, e.g., the operating system may be unaware that the heterogeneous memory system 125 is made up of more than one memory module 120-123. In some embodiments, the physical address space of the heterogeneous memory system 125 is mapped to one or more virtual address spaces.

The memory modules 120-123 may operate according to different memory access protocols. For example, the memory modules 120, 122 may be nonvolatile RAM (NVRAM) that operate according to a first memory access protocol and the memory modules 121, 123 may be dynamic RAM (DRAM) that operate according to a second memory access protocol that is different than the first memory access protocol. Examples of memory access protocols include double data rate (DDR) access protocols including DDR3 and DDR4, phase change memory (PCM) access protocols, flash memory access protocols, and the like. Access requests to the memory modules 120, 122 are therefore provided in a different format than access requests to the memory modules 121, 123.

The memory modules 120-123 may also have different memory access characteristics. For example, the length of the memory rows in the memory modules 120, 122 may differ from the length of the memory rows in the memory modules 121, 123. The memory modules 120-123 may include row buffers that hold information fetched from rows within the memory modules 120-123 before providing the information to the processor cores 105-108, the local caches 110-113, or the shared cache 115. The sizes of the row buffers may differ due to the differences in the length of the memory rows in the memory modules 120-123. The memory modules 120-123 may also have different access request latencies, different levels of access request concurrency, different bandwidths, different loads, and the like.

Memory controllers 130, 135 are used to control access to the memory modules 120-123. For example, the memory controllers 130, 135 can receive access requests (such as read requests and write requests) from a last-level cache such as the shared cache 115 and then selectively provide the access requests to the memory access modules 120-123 based on physical addresses indicated in the requests. The memory controllers 130, 135 are implemented as a hierarchical, distributed memory controller that includes a master controller and local controllers associated with corresponding memory modules 120-123. The master controller receives the access requests that target the memory modules 120-123 and distributes the access requests to the local controllers based on the physical address indicated in the access request. The local controllers can schedule the access requests to the corresponding memory modules 120-123 based (a) on the access protocol of the memory modules 120-123 served by the corresponding local controller and (b) on control information generated by the master controller using statistical representations of access requests to the memory modules 120-123. For example, the master controller may include a global queue inspector the monitors access requests to all of the memory modules 120-123 and generates the statistical representations.

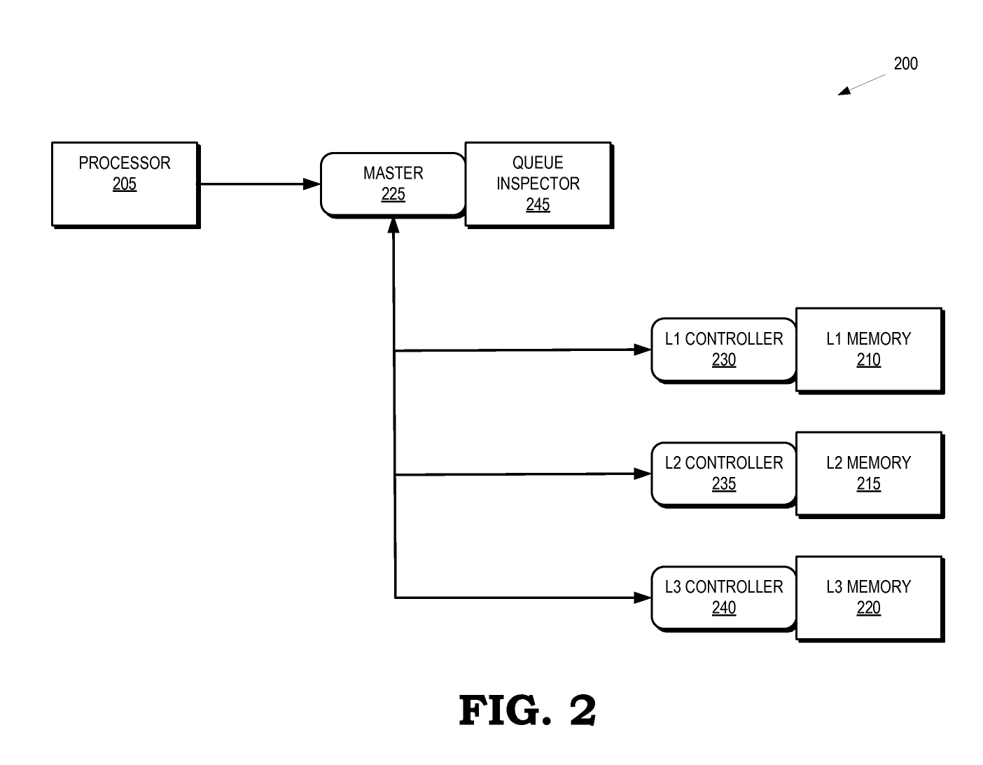

FIG. 2 is a block diagram of a processing system 200 that implements a hierarchical memory controller in accordance with some embodiments. The processing system 200 may be used as a portion of some embodiments of the processing system 100 shown in FIG. 1. The processing system 200 includes a processor 205 that can generate access requests, e.g., in response to cache misses at a last level cache such as the shared cache 115 shown in FIG. 1. The access requests include physical addresses that indicate a location in memory implemented by the processing system 200. In some embodiments, the access requests are generated by threads that are executing on the processing system 200 and the access requests may therefore include a thread identifier that indicates that the access request is in the thread indicated by the thread identifier. Threads and thread identifiers can be allocated by an operating system implemented by the processing system 200, by a user via an application programming interface (API), or by the processing system 200.

The processing system 200 includes three memory levels that correspond to an L1 memory module 210, an L2 memory module 215, and an L3 memory module 220. The memory modules 210, 215, 220 operate according to different memory access protocols and some embodiments of the memory modules 210, 215, 220 are distinguished based on different capacities, latencies, access bandwidths, cost, die area, density of memory elements, and other characteristics. For example, the L1 memory module 210 may be implemented as a die-stacked DRAM that has relatively low latency (compared to the memory modules 215, 220) but the size and capacity of the L1 memory module 210 may be limited by heat, cost, interposer die area, and the like. The L2 memory module 215 may be an on-package NVRAM that has a higher latency than the L1 memory module 210 but provides greater capacity at lower cost than the L1 memory module 210. The L3 memory module 220 may be an off-package main memory implemented as NVRAM that has a relatively higher latency (compared to the memory modules 210, 215) but may also have a larger size and capacity relative to the memory modules 210, 215. The memory modules 210, 215, 220 may also support different data rates. For example, the memory modules 210, 215 may be quad data rate memories and the L3 memory module 220 may be a dual data rate memory.

A master controller 225 receives access requests from the processor 205 and selectively provides the access requests to local controllers 230, 235, 240 that are associated with the memory modules 210, 215, 220, respectively. The master controller 225 also provides control information to the local controllers 230, 235, 240, which can use the control information to schedule access requests to the corresponding memory modules 210, 215, 220. The control information may include information indicating priorities associated with the access requests or corresponding threads, prefetch requests determined based on access patterns associated with different threads, and the like. Some embodiments of the master controller 225 append the control information to the access requests prior to sending the access requests to the local controllers 230, 235, 240. The master controller 225 may also send control information in commands that are separate from the access requests, such as commands to load pages or prefetch information from the memory modules 210, 215, 220.

The master controller 225 communicates with a queue inspector 245. The queue inspector 245 monitors access requests handled by the master controller 225 and is aware of memory characteristics such as the available overall memory bandwidth for the memory modules 210, 215, 220. The queue inspector 245 may also determine parameters such as the average latency, average bandwidth, and load for the memory modules 210, 215, 220 and the corresponding local controllers 230, 235, 240 by monitoring responses coming from memory modules 210, 215, 220. Some embodiments of the queue inspector 245 determine data usage patterns for threads or applications based on profiling, an access history indicated by the monitored access requests, information provided by caches such as the local caches 110-113 and the shared cache 115 shown in FIG. 1, explicit hints from the applications, and the like.

Each local controller 230, 235, 240 is responsible for managing memory traffic directed to the corresponding memory module. Some embodiments of the local controllers 230, 235, 240 receive global control information generated by the master controller 225 based on information provided by the queue inspector 245. The local controllers 230, 235, 240 use the control information to schedule or prioritize outstanding or future access requests. The local controllers 230, 235, 240 may implement one or more scheduling algorithms that operate in accordance with the memory access protocols for the corresponding memory modules 210, 215, 220. The scheduling algorithms also satisfy programmable or configurable constraints such as performance or power constraints on energy consumption, bandwidth, latency, and the like. Some embodiments of the local controllers 230, 235, 240 schedule the access requests based on memory-specific objectives such as write endurance for NVRAMs.

The local controllers 230, 235, 240 may provide feedback signaling to the master controller 225 or the queue inspector 245. For example, the queue inspector 245 can receive feedback signaling from the local controllers 230, 235, 240 that indicates an average read or write bandwidth, a rate of energy consumption, and a latency of access requests for each of the local controllers 230, 235, 240. The signaling may be received periodically, at predetermined time intervals, in response to events detected by the processing system 200, or at other times. The queue inspector 245 may use the feedback signaling to generate the statistical representations of the access requests and the statistical representations can be updated based on the received feedback signaling. The queue inspector 245 may also track the number of pending read and write requests for each of the local controllers 230, 235, 240 by monitoring access requests received by the master controller 225 in response to cache misses (which may increase the number of pending read or write requests) and outgoing responses to the access requests generated by local controllers 230, 235, 240 in response to completing the memory access (which may decrease the number of pending read or write requests). The numbers of pending read and write requests may be incorporated into the statistical representation of the memory activity. Latencies of the access requests may be determined by measuring the time that the access requests spend queued at the local controllers 230, 235, 240 before completion.

The master controller 225 uses information provided by the queue inspector 245 to generate the control information that is provided to the local controllers 230, 235, 240. For example, the queue inspector 245 can determine a number of outstanding read or write requests for a first thread by detecting a first thread identifier in the read or write requests. If the outstanding requests are directed to one of the memory modules 210, 215, 220 that is experiencing a high average latency (relative to the other memory modules), the master controller 225 may transmit control information to the local controllers 230, 235, 240 that is used to delay access requests in the first thread to the other, faster memory modules. Delaying the other access requests provides additional time for the outstanding requests directed to the high latency memory module to complete, while also freeing up read and write bandwidth in the local controllers associated with the faster memory modules to complete access requests for other threads. Delaying the other access requests for the first thread is unlikely to significantly impact the first thread since the outstanding access requests to the high latency memory module is likely to be the bottleneck for the first thread. For example, GPU threads may be grouped in wavefronts and each GPU thread in a wavefront only makes forward progress on instruction execution when all threads within the wavefront complete their memory access.

The queue inspector 245 can improve the performance of latency bound threads by assigning different priorities to their requests. For example, the set of memory modules 210, 215, 220 may include a faster (lower latency) DRAM memory module 210 and a slower (higher latency) NVRAM memory module 215. An operating system of the processing system 100 (or other mechanism) may map latency critical data to the faster memory module 210. If the queue inspector 245 observes that a relatively large number of the access requests for a first thread are directed to the faster memory module 210 and a relatively small number of the access requests for the first thread are directed to the slower memory module 215, the queue inspector 245 determines that the first thread is latency bound. The master controller 225 may also prioritize access requests by the first thread (relative to access requests by other threads) to the memory modules 210, 215, 220, as well as prioritizing forwarding the responses to the cache hierarchy in the processing system 200. Some embodiments of the queue inspector 245 provide information indicating the latency-bound status of threads to the memory controllers 230, 235, 240 so they can prioritize servicing requests by the latency-bound threads.

The queue inspector 245 can determine access patterns for the threads handled by the master controller 225. For example, the queue inspector 245 can detect a linear stride in the access requests in the last-level cache miss stream of a thread, even though the access requests may not all be directed to the same memory module 210, 215, 220. The master controller 225 may use the access patterns to provide control information instructing the local controllers 230, 235, 240 to open memory pages prior to arrival of the access requests to those pages and to prefetch based on the predicted access patterns. Training on the access patterns is more effective at the level of the master controller 225 and the queue inspector 245 than at the level of the local controllers 230, 235, 240 for at least two reasons. First, the memory traffic arriving at each of the local controllers 230, 235, 240 is only a subset of the last-level cache miss traffic that arrives at the master controller 225. Second, some embodiments of the master controller 225 make scheduling decisions that change the order of the access requests that are sent to the local controllers 230, 235, 240, which makes access pattern detection more difficult at the local controllers 230, 235, 240.

QoS guarantees for different threads can be enforced by the master controller 225 on a per-thread basis. The QoS requirements may be represented as a set of latency or bandwidth requirements, which may be programmed at the BIOS level. Threads can then be allocated to one of the sets corresponding to a particular QoS requirement that guarantees a particular average latency or bandwidth. Allocation of the threads can be performed by an operating system, by the user via an application programming interface (API), or by the processing system 200. The QoS of each thread is communicated to the queue inspector 245 along with the thread identifier in the access requests in the thread. The master controller and the queue inspector 245 may then issue access requests from the different threads to the local controllers 230, 235, 240 based on feedback indicating the current average latency or bandwidth at the memory modules 210, 215, 220. For example, the target latency or target bandwidth indicated by the QoS requirements for each access request can be compared to the current average latency or bandwidth. The next access request may be picked for transmission to a local controller in response to the target latency or bandwidth being satisfied by the current average latency or bandwidth at the local controller. As another example, the average latency or average bandwidth of each thread can be periodically communicated to the local controllers 230, 235, 240 via explicit messages, allowing the local controllers 230, 235, 240 to adjust their scheduling decisions regarding the pending requests of each thread to meet the QoS requirements of each thread.

Some embodiments of the master controller 225 categorize the access requests using multiple dimensions such as the dimensions of latency, jitter, and bandwidth sensitivity of the access request. The queue inspector 245 may monitor metrics including inter-arrival times of access requests, cache hit rates, cache miss rates, and the like to assign values to the three dimensions for each access request. The values of the three dimensions may be normalized, such as normalized based on values determined over a predetermined time interval. The queue inspector 245 may then use the normalized values to assign priorities to the access request as a function of the normalized latency, bandwidth, and jitter. Some embodiments of the queue inspector 245 assign the priorities based on global bandwidth sharing or, if bandwidth demand is low, then the global bandwidth may be partitioned among many applications.

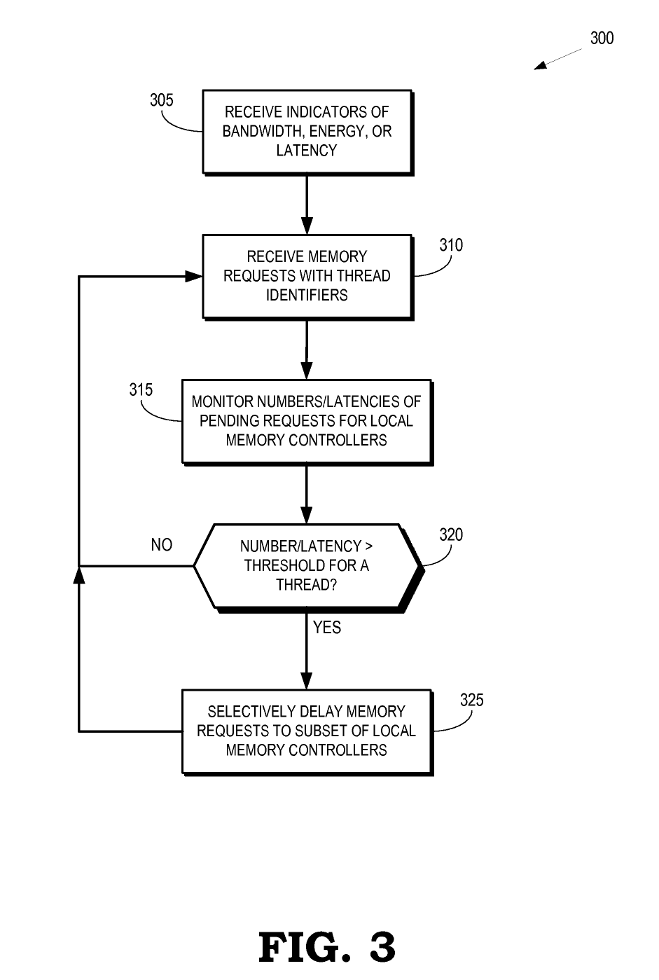

FIG. 3 is a flow diagram of a method 300 for selectively delaying access requests to one or more local controllers on a per-thread basis according to some embodiments. The method 300 may be implemented in some embodiments of the processing system 100 shown in FIG. 1 or the processing system 200 shown in FIG. 2.

At block 305, a master controller or queue inspector receives indicators of metrics such as bandwidth, energy consumption, or latency for a plurality of memory modules that are controlled by a corresponding plurality of local controllers. At block 310, the master controller receives one or more access requests including thread identifiers that indicate that the access request belongs to a corresponding thread. The access requests are directed to the memory modules associated with the local controllers, as indicated by addresses in the access requests. At block 315, the queue inspector monitors a number of pending access requests to the local controllers for each thread at each of the local controllers. The queue inspector may also monitor latencies of the pending requests for each thread at each of the local controllers.

At decision block 320, the master controller or the queue inspector compares the number or latencies of the pending access requests to corresponding threshold values for each thread. The threshold values are defined at each local controller and may be the same or different for the different local controllers. As long as the number or latency of the pending access requests for each thread at each local controller is below the corresponding threshold value, the master controller and queue inspector continue to receive and monitor access requests. The method 300 flows to block 325 in response to the number or latency of pending requests associated with one or more threads exceeding the corresponding threshold value at one or more of the local controllers.

At block 325, the master controller selectively delays access requests to a subset of the local controllers. For example, if the number or latency of pending requests in a first thread exceeds its corresponding threshold value at a first local controller, the master controller may determine that the first thread is latency bound at the first local controller. The master controller may therefore provide control information to the first local controller and one or more second local controllers to establish priorities for scheduling the pending requests in the first thread and one or more second threads at the local controllers. The priority for scheduling access requests in the first thread at the one or more second local controllers may be reduced (relative to the priorities for scheduling access requests in other threads) to selectively delay the access requests in the first thread. The master controller and queue inspector may then continue to receive and monitor access requests. In some embodiments, the master controller modifies the priorities in response to the number or latency of pending requests falling below the corresponding threshold at decision block 320. For example, the master controller may return the priorities to a previous value that gives equal priority to access requests in the first thread and the one or more second threads.

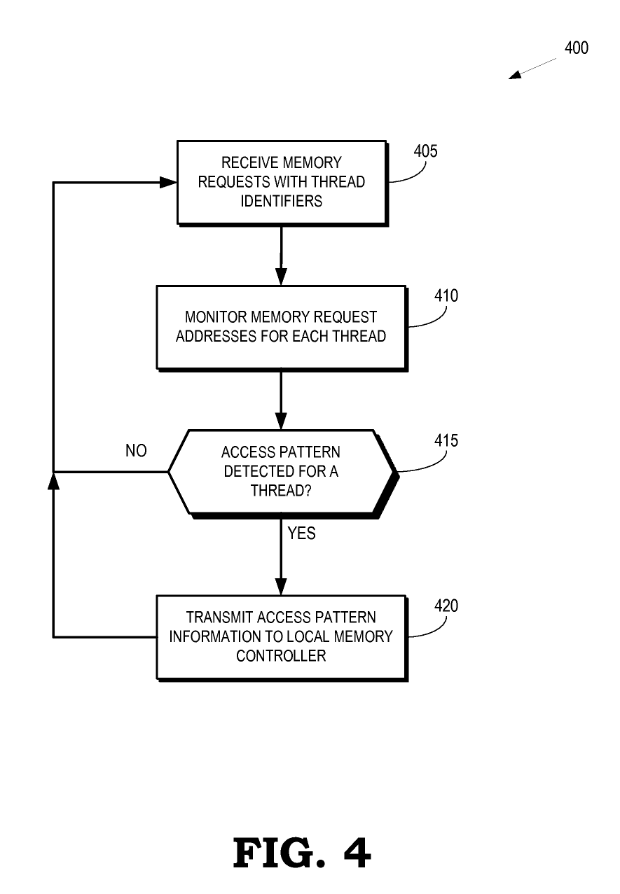

FIG. 4 is a flow diagram of a method 400 for identifying access patterns on a per-thread basis according to some embodiments. The method 400 may be implemented in some embodiments of the processing system 100 shown in FIG. 1 or the processing system 200 shown in FIG. 2.

At block 405, a master controller receives one or more access requests including thread identifiers that indicate that the access request is in a corresponding thread. The access requests also include addresses for the access requests. At block 410, the master controller or a queue inspector monitors the access request addresses for each thread. For example, the master controller or the queue inspector may maintain a record of the addresses of a predetermined number of previous access requests for each thread. The master controller or the queue inspector may then analyze the previous addresses to detect access patterns for the different threads.

At decision block 415, the master controller determines whether an access pattern has been detected for one or more of the threads. For example, if the addresses of the previous requests in a thread are (A), (A+1), and (A+2), the memory controller or queue inspector determines an access pattern defined by a linear stride of degree 1 in the direction of increasing address. For another example, if the addresses of the previous requests in a thread are (A), (A−2), and (A−4), the memory controller or queue inspector determines an access pattern defined by a linear stride of degree 2 in the direction of decreasing address. As long as no access pattern is detected, the master controller and the queue inspector continue to receive and monitor access requests. The method 400 flows to block 420 in response to detection of one or more access patterns.

At block 420, the master controller generates control information based on the detected access patterns and provides the control information to one or more of the local controllers. For example, if the master controller detected an access pattern for a thread that is providing access requests to one or more memory modules, the master controller generates and transmits control information that enables the local controller for those memory modules to prefetch data from their respective memory module based on the access pattern. The control information may include information identifying the access pattern. In some embodiments, the control information is provided in an explicit command that is sent to the local controller to instruct the local controller to prefetch the data from memory locations indicated by the access pattern.

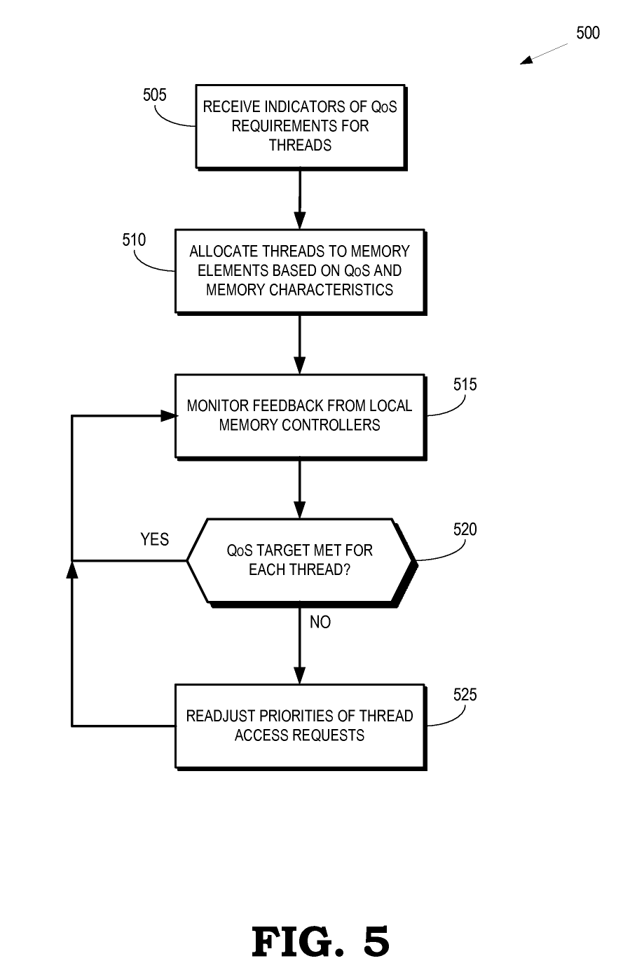

FIG. 5 is a flow diagram of a method 500 for enforcing quality-of-service (QoS) requirements on a per-thread basis according to some embodiments. The method 500 may be implemented in some embodiments of the processing system 100 shown in FIG. 1 or the processing system 200 shown in FIG. 2.

At block 505, a master controller receives indicators of QoS requirements for one or more threads. The QoS requirements may be provided as a minimum value of a bandwidth available to the thread, a maximum value of a latency for access requests, minimum or maximum values of statistical combinations such as averages of the bandwidths or latency, and the like. At block 510, the master controller adjusts the priorities of new requests of the threads to memory elements based on the characteristics of the memory elements and the QoS requirements for the threads. The allocation can be indicated to local controllers using control information. For example, the access requests of a first thread that has a first latency requirement may be serviced by a memory module that has a current average latency that is less than the first latency requirement. In some embodiments, the master controller may boost the priority of the requests of the first thread serviced by the memory module as long as their current average latency is less than the first latency requirement.

At block 515, the master controller or a queue inspector monitors feedback from the local controllers. The feedback may indicate current average values of the bandwidths available to threads, the latency for access requests, and the like.

At decision block 520, the master controller or the queue inspector determines whether the QoS targets are being met for the threads based on their current allocation to memory modules and the feedback received from the local controllers. As long as the QoS targets are being met, the master controller or the queue inspector continues to monitor feedback from the local controllers at block 515. If the QoS target for one or more of the threads is not satisfied, the master controller can readjust the priority of the requests of those threads to the memory elements at block 525. For example, if the feedback from a first local controller indicates that the latency of the corresponding memory module has increased so that it is larger than the maximum latency indicated by the QoS requirements for the first thread, the master controller can readjust the priority of the requests of the first thread to that memory module until the latency is lower than the maximum latency indicated by the QoS requirements. Some embodiments of the master controller also provide control information that attempts to reduce the latency at the first local controller. For example, the master controller may reduce the priorities for access requests in other threads (relative to the priority of access request and the first thread) that are directed to the first local controller.

In some embodiments, the apparatus and techniques described above are implemented in a system comprising one or more integrated circuit (IC) devices (also referred to as integrated circuit packages or microchips), such as the processing systems described above with reference to FIGS. 1-5. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
a plurality of first controllers that operate according to a plurality of access protocols to control a plurality of memory modules; and
a second controller to receive access requests that target the plurality of memory modules and selectively provide the access requests and control information to the plurality of first controllers based on physical addresses in the access requests, wherein the second controller generates the control information based on statistical representations of the access requests to the plurality of memory modules.

2. The apparatus of claim 1, wherein each of the plurality of first controllers schedules access requests based on the access protocol of the corresponding memory module and the control information generated by the second controller.

3. The apparatus of claim 1, further comprising:
a queue inspector to monitor the access requests to the plurality of memory modules and to generate the statistical representations.

4. The apparatus of claim 3, wherein the second controller generates the control information comprising different priorities for the access requests in different threads, wherein the priorities are based on at least one of average response latencies for access requests in the different threads, average bandwidths associated with the memory modules, and average loads on the memory modules generated by the queue inspector.

5. The apparatus of claim 3, wherein the queue inspector generates the statistical representation based on a number of pending read or write requests for different threads from a last-level cache to each of the first controllers.

6. The apparatus of claim 3, wherein the queue inspector generates the statistical representation based on feedback received from the plurality of first controllers.

7. The apparatus of claim 6, wherein the feedback comprises information indicating at least one of an average read or write bandwidth for at least one of the plurality of first controllers, energy consumption by at least one of the plurality of first controllers, errors detected by at least one of the plurality of first controllers, and an average read or write latency of access requests to at least one of the plurality of memory modules associated with at least one of the plurality of first controllers.

8. The apparatus of claim 3, wherein the queue inspector detects access patterns in the access requests and the second controller issues commands to at least one of the plurality of first controllers to prefetch data from at least one of the plurality of memory modules based on the detected access patterns.

9. The apparatus of claim 1, wherein the second controller generates the control information for access requests in different threads based on quality-of-service (QoS) guarantees for the different threads.

10. A method comprising:
receiving, at a first controller, an access request targeted to one of a plurality of memory modules controlled by a corresponding a plurality of second controllers that operate according to a plurality of access protocols;
selectively providing the access request from the first controller to the one of the plurality of second controllers based on a physical address in the access request; and
providing control information from the first controller to the one of the plurality of second controllers, wherein the first controller generates the control information based on statistical representations of access requests to the plurality of memory modules.

11. The method of claim 10, further comprising:
scheduling, at the one of the plurality of second controllers, the access request based on the access protocol of the corresponding memory module and the control information generated by the first controller.

12. The method of claim 10, further comprising:
generating, at the first controller, the control information comprising different priorities for the access requests in different threads, wherein the priorities are based on at least one of average response latencies for access requests in the different threads, average bandwidths associated with the memory modules, and average loads on the memory modules.

13. The method of claim 10, further comprising:
generating, at a queue inspector, the statistical representation based on a number of pending read or write requests in different threads from a last-level cache to each of the second controllers.

14. The method of claim 10, further comprising:
generating, at a queue inspector, the statistical representation based on feedback received from the plurality of second controllers.

15. The method of claim 14, wherein the feedback comprises information indicating at least one of an average read or write bandwidth for at least one of the plurality of second controllers, energy consumption by at least one of the plurality of second controllers, errors detected by at least one of the plurality of second controllers, and an average read or write latency of access requests to at least one of the plurality of memory modules associated with at least one of the plurality of second controllers.

16. The method of claim 10, further comprising:
appending the control information to the access requests prior to selectively providing the access requests to the plurality of second controllers.

17. The method of claim 10, further comprising:
detecting, at a queue inspector, access patterns in the access requests; and
issuing, from the first controller, commands to at least one of the plurality of second controllers to prefetch data from at least one of the plurality of memory modules based on the detected access patterns.

18. The method of claim 10, further comprising:
generating, at the first controller, the control information for access requests in different threads based on quality-of-service (QoS) guarantees for the different threads.

19. A non-transitory computer readable storage medium embodying a set of executable instructions, the set of executable instructions to manipulate a computer system to perform a portion of a process to fabricate at least part of a processor, the processor comprising:
a plurality of first controllers that operate according to a plurality of access protocols to control a plurality of memory modules; and
a second controller to receive access requests that target the plurality of memory modules and selectively provide the access requests and control information to the plurality of first controllers based on physical addresses in the access requests, wherein the second controller generates the control information for the first controllers based on statistical representations of the access requests to the plurality of memory modules.

20. The non-transitory computer readable storage medium of claim 19, wherein the set of executable instructions is to manipulate the computer system to perform a portion of the process to fabricate at least part of the processor, the processor further comprising:
a queue inspector to monitor the access requests to the plurality of memory modules and generate the statistical representations.
